(19) United States
(12) Patent Application Publication
(10) Pub. No.: US 2002/0057767 A1
(43) Pub. Date: May 16, 2002

(54) METHOD AND APPARATUS FOR USING A SERVICE MADE AVAILABLE IN A TELECOMMUNICATIONS NETWORK

(76) Inventor: JOACHIM POSEGGA, BRUCHSAL (DE)

Correspondence Address: KENYON & KENYON, ONE BROADWAY, NEW YORK, NY, 10004, US

(21) Appl. No.: 09/054,597

(22) Filed: Apr. 3, 1998

(30) Foreign Application Priority Data
Apr. 4, 1997 (DE) 197 13 966.3

(51) Int. Cl. H04M 1/64; H04M 3/42

(52) U.S. Cl. 379/88.01; 379/201.01

(57) ABSTRACT

A device for using a service that is made available in a telecommunications network. A user-side terminal (3) can be connected to at least one network server (1), and a control device (5) executes an interface program. The control device (5) is assigned to the terminal (3) and is used for controlling and operating the service. The interface program, before the service is used, is transmitted by the network server (1) to the control device (5). Also provided is a method for using a service made available in a telecommunications network, the user interface being transmitted from the network server (1) to the control device (5) and being executed there.

### FIELD OF THE INVENTION

The present invention relates to telecommunications networks, and, in particular, to a device and method for using a service which is made available in a telecommunications network.

### RELATED TECHNOLOGY

Until now, telecommunications networks have been used mainly to transmit information from one user to another. However, to an increasing extent telecommunications networks are also being employed to transmit data or programs. In this case, the communication takes place between a network server and the user-side terminal. The high performance of such network servers makes it possible to run programs on the network server. The terminal functions as a control and operating device. For control and operating functions the terminal must have available to it the necessary hardware and software. The terminal must be specifically adjusted to the program being controlled.

A modification of the program on the network server, to add further functions for example, requires a corresponding modification of the user-side software and/or hardware. However, this user-side modification can be very expensive and adversely affect user productivity. The terminal is out of productive service during implementation of such modification. The disadvantageous nature of this situation is exacerbated because programs are regularly, and at relatively short intervals, replaced by upgrades. This applies to both the user side and the network server.

### SUMMARY OF THE INVENTION

Therefore, an object of the present invention is to provide a device and a method by which a network-based service can be used without the need for a terminal that is specifically adjusted to the service.

The present invention therefore provides a device for using a service that is made available in a telecommunications network, having a user-side terminal (3), which can be connected to at least one network server (1), and having a control and operating device (5) executing a user interface, said control and operating device (5) being assigned to a terminal (3) and being used for controlling and operating the service, the interface program, before service is used, being transmitted by the network server (1) to the control device (5).

The present invention also provides a method for using a service that is made available in a telecommunications network, by at least one user interface program being stored in a network server (1), said program providing the operating functionality, and by the user interface program, before the service is used, being called-up by a user-side control device (5) or a terminal (3) and being executed by the control device, so that the operator can operate/control the service by means of the user interface.

According to the present invention, a control device used for controlling or operating the service is assigned to the user-side terminal. The control device executes a user, or operator, interface program which, before the service is used, is transmitted as an executable program from the network server to the control system. The user interface is necessary for the operation and control of the service and is processed by the control device. Either the user-side terminal or the control device may be used to call up the interface program. The user-side terminal, as such, is independent of the service that is to be used.

An advantage of the device and method of the present invention is that the user does not need a terminal that is specifically adjusted to the service to be used. The user does not have to be concerned with program modifications or upgrades. The service provider does not have to worry about securing upgrades or modifying the user's hardware.

The present invention has proved to be particularly advantageous in connection with a speech recognition system which is made available as a network-based service. The service converts speech into text. A network server performs the speech conversion. In this embodiment the microphone of a telephone functions as the speech input means. Preferably a computer functions as the control device. In this embodiment the user interface, realized through software, comprises a window for displaying the text. The user interface may also include operating devices for controlling speech recognition, e.g., for stopping, starting, or editing.

A very effective speech recognition system can be achieved when the device of the present invention is connected to the network server over an ISDN network. The telephone, for providing speech input, may be assigned to one of the two ISDN channels, and the control device assigned to the other ISDN channel.

It is particularly advantageous to execute the interface programs, which are transmitted by the network server to the control device, as so-called JAVA applets. “JAVA” signifies a programming language developed by Sun Microsystems. JAVA executable programs, or so-called applets, may be made available in a network and, when needed, downloaded by a network user and executed. The user-side terminal and/or the control device preferably have a JAVA time-execution environment. The control device preferably comprises a processor which functions as a so-called “JAVA virtual machine”(stack machine) for executing the JAVA applet.

Other advantageous embodiments of the present invention include:

(a) that the terminal (3) is a telephone;

(b) that the service is a speech recognition system;

(c) that the invention can be connected by means of an ISDN line (7) to the network server (1), one channel being provided for the terminal (3) and another channel for the control device (5);

(d) that a microphone of the telephone is used for inputting speech and the control device (5) for displaying the text;

(e) that the control device (5) comprises a JAVA processor;

(f) that the control device (5) is a computer;

(g) that the control device and/or the terminal has a JAVA execution-time environment;

(h) that the user interface program is provided as a JAVA applet; and

(i) that a speech processing is performed as a service, the speech input being carried out by the terminal (3) and the display of the text being carried out by the control device (5), the conversion of speech into text being carried out by the network server (1).

### BRIEF DESCRIPTION OF THE DRAWINGS

The present invention will now be elucidated on the basis of an exemplary embodiment, with reference to the drawings in which:

FIG. 1 shows a schematic representation of a system for using a network-based service, and

FIG. 2 shows a schematic representation of a network-based speech recognition system.

### DETAILED DESCRIPTION

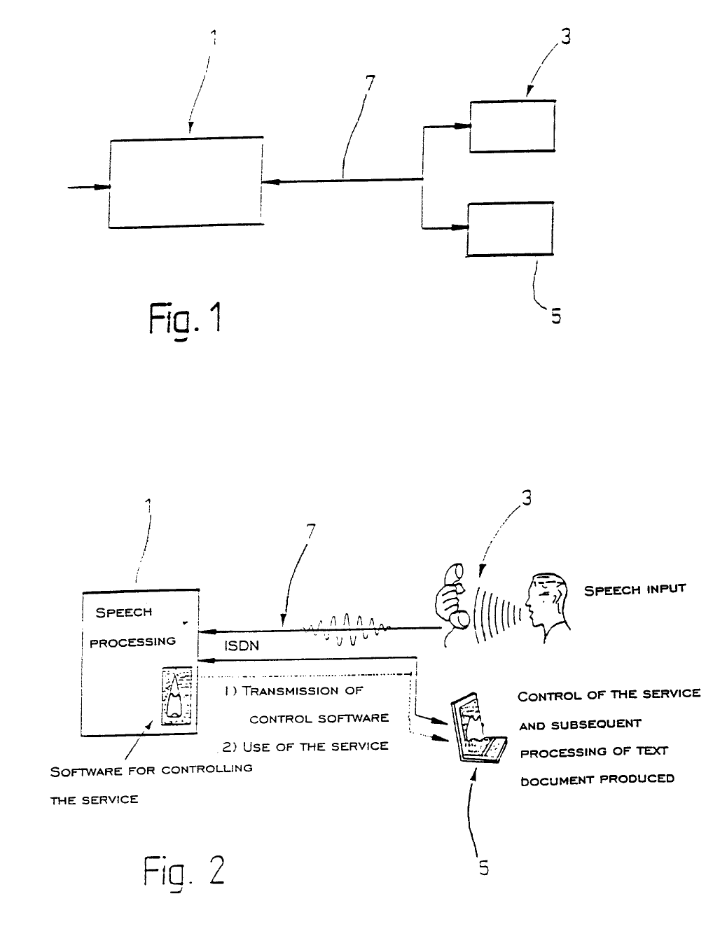

FIG. 1 depicts components of a telecommunications network of one embodiment of the present invention. As embodied herein, the components are a network server 1, a terminal 3, as well as a control and operating device 5, hereinafter referred to as control device 5. The three components mentioned are connected to each other by a network 7 preferably through dial-up, rather than dedicated, connections. For the sake of simplicity, the necessary switching centers for providing dial-up connections are not shown in FIG. 1.

Network server 1 makes available certain services which can be dialed up by the user. Service, in this connection, signifies a program which is executed by the network server and which performs certain tasks for the user. One example, which will be explained in greater detail in reference to FIG. 2, is a speech recognition system. The a speech recognition system speech, which has been input by the user, is converted into a text available to the user for further processing. Of course, the present invention is not limited to speech recognition systems. Other services are both conceivable and practicable.

In telecommunications networks, terminal 3 is usually a telephone, fixed or mobile. For the sake of simplicity, a necessary conversion from wire-bound data transmission to a wireless radio transmission is not depicted in network 7.

Control device 5 is a unit which is capable of processing programs and making a user interface available to the user. The user interface, in this connection, permits a program, or service, to be operated and controlled. Preferably, control device 5 includes a keyboard and a display unit, the display unit being provided for displaying an operator interface. In the present exemplary embodiment, control device 5 comprises a processor which can process JAVA applets.

FIG. 1 depicts terminal 3 and control device 5 as separate components. In other embodiments of the present invention, both components may be combined into one unit. For example, in one embodiment of the invention terminal 3 and control device 5 are combined in one computer. In this embodiment the computer additionally comprises a microphone and loudspeaker so that it may perform the functions of a telephone. In other embodiments of the present invention, only an individual control component, such as the keyboard, is combined with terminal 3. In one such embodiment the keyboard on a telephone is preferably used as the user input device.

Communication between network server 1, terminal 3 and control device 5 takes place over network 7 in analog or digital form. Preferably, the Internet protocol is used as the communications protocol between network server 1 and control device 5.

Using the above-mentioned network server 1, terminal 3, control device 5 and network 7, the following embodiment of a method for using a service made available on a network can be carried out:

Network server 1 makes a given service available, which can be dialed, or called up by a user with the help of terminal 3 or control device 5. A program for implementing this service is stored in the network server. The program executes the desired tasks or functions of the service. Preferably, the user inputs certain user data, which then are processed by the program in network server 1. The result is subsequently transmitted to control device 5 for display. Appropriate user controls for controlling the service are provided. As embodied herein user control is achieved through a user interface which comprises fields for the inputting of data and switching elements for starting and stopping the service. The switching elements are preferably activated by keyboard or mouse. In other embodiments of the present invention number-keys of the telephone are assigned to the switching elements.

The program itself is preferably executed as a JAVA applet so that platform independence is achieved. The program made available by network server 1 is independent of the hardware configuration of control device 5. When, by the appropriate input, the user terminates use of the service, the execution of the program in control device 5 is interrupted and the program is deleted. The user then may use another service made available by network server 1 or by another network server.

As previously noted, in one embodiment of the present invention the service provided is a speech recognition system. The speech recognition system is designed to provide the user with the ability to convert spoken speech into text that is capable of being further processed. Such capability obviates the need for manual inputting of the text into a computer.

The speech recognition embodiment of the present invention may be explained with reference to FIG. 2. Terminal 3 serves as the required speech input unit. As embodied herein terminal 3 comprises a telephone. Control device 5 controls the speech recognition process. For example, control device 5 interrupts the recording of speech as necessary. As embodied herein, control device 5 comprises a computer. Control device 5 preferably comprises a computer which displays and enables correcting of text, in addition to performing its control function.

As embodied herein, the user interface provides a window for displaying the text, switching elements for starting and stopping the speech recording, and certain control elements for correcting the text. The user interface program is transmitted, before the actual service is used, from network server 1 over network 7 to control device 5, where it is executed. In addition to displaying the operator interface, the user interface program converts user inputs made via keyboard and mouse into control signals transmits them to network server 1. The user interface program also displays data received from network server 1. As embodied herein this data is text.

As embodied herein, a user calls up the service by dialing up network server 1 using telephone 3, which is preferably a telephone. As soon as a connection is established, network server 1 will transmit to control device 5 the program required for using the service. In this way the user interface is established, permitting the user to start the actual service.

As depicted in FIG. 2, the connection between network server 1 and the two components 3 and 4 is preferably effected via an ISDN line. Since two communications channels a and b are available with every ISDN access, speech can be transmitted over the first channel while communication between network server 1 and control device 5 can be carried over the second channel. In this way a higher data transmission rate may be achieved.

As embodied herein, network server 1 transmits the user interface program as a JAVA applet. Computer 5 preferably runs a conventional World Wide Web (www) browser, such as those developed by Netscape or Microsoft, to execute the program. Familiar commands may thus be employed to use the service.

What is claimed:

1. A device for using a service made available in a telecommunications network, the device comprising:
at least one network server having an interface program;
a user-side terminal, the user-side terminal being capable of connection to the at least one network server; and
a control and operating device executing a user interface to control and operate the service;
wherein the control and operating device is assigned to the user-side terminal and the at least one network server transmits the user interface program to the control and operating device before service is used.

2. The device as recited in claim 1 wherein the user-side terminal includes a telephone.

3. The device as recited in claim 1 wherein the service includes a speech recognition system.

4. The device as recited in claim 1 further comprising an ISDN line connected to the at least one network server, a first channel of the ISDN line being assigned to the user-side terminal and a second channel of the ISDN line being assigned to the control and operating device.

5. The device as recited in claim 2 wherein a microphone of the telephone is used for inputting speech and the control and operating device is used for displaying text.

6. The device as recited in claim 1 wherein the control and operating device includes a JAVA processor.

7. The device as recited in claim 1 wherein the control and operating device includes a computer.

8. The device as recited in claim 1 wherein the control and operating means includes a JAVA execution-time environment.

9. The device as recited in claim 1 wherein the terminal includes a JAVA execution-time environment.

10. A method for using a service made available in a telecommunications network wherein at least one network server stores at least one user interface program, the at least one user interface program providing operating functionality, said method comprising:
using a user-side control and operating device or terminal to call-up the user interface program before the service is used, and
executing the user interface program by the control and operating device, so that an operator can control and operate the service through a user interface.

11. The method as recited in claim 10 wherein the user interface program is provided as a JAVA applet.

12. The method as recited in claim 11 wherein the service provides processing of speech into text, speech input being carried out using the terminal, display of the text being carried out using the control and operating device, and conversion of speech into text being carried out by the at least one network server.
